(19) United States
(12) Patent Application Publication
(10) Pub. No.: US 2004/0015777 A1
(43) Pub. Date: Jan. 22, 2004

(54) System and method for sorting embedded content in Web pages

(75) Inventors: Hui Lei, Scarsdale, NY (US); Yiming Ye, White Plains, NY (US); Philip S. Yu, Chappaqua, NY (US)

Correspondence Address: Steven Fischman, Scully, Scott, Murphy & Presser, 400 Garden City Plaza, Garden City, NY, 11530, US

(73) Assignee: INTERNATIONAL BUSINESS MACHINES CORPORATION, ARMONK, NY

(21) Appl. No.: 10/201,420

(22) Filed: Jul. 22, 2002

(51) Int. Cl. G06F 15/00

(52) U.S. Cl. 715/500

(57) ABSTRACT

A system and method for prioritizing information items embedded in documents, for example, web-based documents such as HTML, XML, and the like. One or more feature vectors for the embedding document are first constructed. The feature vectors include: a content feature vector and an attribute feature vector, or both, with the content feature vector characterizing content of the document, the attribute feature vector characterizing attributes of the document. One or more feature vectors are also constructed for an embedded item in the document, the feature vectors also including: a content feature vector and an attribute feature vector, or both. Then, a similarity measure is computed between the item embedded in the document and the embedding document, the similarity measure based on a comparison of either the respective content feature vector and an attribute feature vector, or both, for each embedded item and embedding document. A priority value is then assigned to the embedded item based on the computed similarity measures. This is preferably an iterative process so that all items embedded in the embedding document may be prioritized.

### BACKGROUND OF THE INVENTION

1. Field of the Invention

The present invention generally relates to the information access over the World Wide Web (“WWW”), and to an improved Web content delivery method and system apparatus that adapts to a variety of client platform characteristics, network constraints, and user interests by prioritizing embedded information items such as inline web objects in a transparent manner.

2. Description of the Prior Art

The World Wide Web (WWW or Web) is a network application that employs the client/server model to deliver information on the Internet to users. A Web server disseminates information in the form of Web pages. Web clients and Web servers communicate with each other via the standard Hypertext Transfer Protocol (HTTP). A (Web) browser is a client program that requests a Web page from a Web server and graphically displays its contents. Each Web page is associated with a special identifier, called a Uniform Resource Locator (URL), that uniquely specifies its location. Most Web pages are written in a standard format called Hypertext Markup Language (HTML). An HTML document is simply a text file that is divided into blocks of text called elements. These elements may contain plain text, multimedia content such as images, sound, and video clips, and even other elements such as applets. Multimedia content typically is represented in a separate file, whose URL is referenced in the HTML code of the encompassing Web page. For example, an HTML element <IMG SRC=http://www.ibm.com/pics/blue.gif> identifies an image that is embedded in the HTML document. Such embedded Web objects are called inline Web objects.

Due to the recent rapid growth of devices that are connected to the Internet, there is a growing demand for providing universal access to the Web to a wide variety of devices over a wide range of network environments. For example, personal computers on a local area network (LAN), personal digital assistants (PDA) on dial-up modems and smart cellular phones have drastically different client resources in terms of network bandwidth, computing power, screen size, resolution, and color depth. Internet users also vary in their ability to pay for Internet services and in the time they are willing to wait for a page to download. Therefore, to provide universal access to the Web, the delivery of Web content need to adapt to the variety of client platform characteristics, network constraints, and user interests.

Adaptive Web content delivery often relies on a capability to distinguish among inline Web objects and sort them based on their importance. U.S. Pat. No. 5,826,031 issued to Nelsen teaches a method for downloading items embedded in a Web page in the descending order of their priorities so that important items are retrieved before less important items and become available to the user sooner. In Adapting Multimedia Internet Content for Universal Access, IEEE Transactions on Multimedia 1(1):104-114, 1999, Mohan, Smith and Li discusses a method for transcoding inline multimedia items in a Web page to optimally match the capabilities of the client device where the resources associated with the client device are allocated among the embedded items according to their priorities.

Unfortunately, existing approaches to prioritizing embedded items have severe limitations. The Nelsen system requires that the document author explicitly assign a priority value to each embedded item. Mohan, Smith and Li suggest a number of other priority assignment schemes in addition to assignment by the author. For instance, priorities may be assigned based on match scores computed by search engines, but this technique is applicable only to Web pages dynamically generated in response to a user query. Alternatively, priorities may be based on the purpose of embedded items as identified by content analysis. However, content analysis, the details of which are described by S. Paek and J. R. Smith in Detecting Image Purpose in World Wide Web Documents, Proceedings of IS&T/SPIE Symposium on Electronic Imaging: Science and Technology—Document Recognition, San Jose, Calif., January 1998, relies on sophisticated decision tree learning and prerequisite training. All these methods require that standard HTML syntax be extended to include item priorities for them to be used on a Web client or a proxy.

As is known in the art, it is possible to compare the relatedness, or similarity, of two entities with respect to certain properties of the entities. First, each entity is represented by a feature vector, where the elements of the vector are features characterizing the entity and each element has a weight to reflect its importance in the representation of the entity. Next, the relatedness of the two entities are computed as the distance between the two corresponding feature vectors. Such a technique is commonly used in text retrieval systems based on a comparison of content features (words and phrases) extracted from the text of documents and queries. The specifics of the feature selection procedures, feature weighting schemes, and similarity metrics as used in text retrieval are generally known to those of ordinary skill in the art. Feature selection and weighting techniques tailored for HTML content are described by D. Mladenic in Machine Learning on Non-Homogeneous Distributed Text Data, Doctoral Dissertation, Faculty of Computer and Information Science, University of Ljubljana, Slovenia, 1998.

Accordingly, a need exists for an improved method for prioritizing inline objects in a Web document.

### SUMMARY OF THE INVENTION

It is an object of the present invention to provide a system and method for prioritizing embedded information items in documents. In a preferred embodiment, the system and method prioritizes information items embedded in web-based documents such as HTML, XML, or the like. In a preferred embodiment, the information items are inline Web objects such as images, sound and video clips, referenced as URLs embedded in a web page, e.g., HTML file.

According to a preferred embodiment of the invention, the method for prioritizing embedded information items in documents includes computing the priority of embedded items as the similarity between the item and the embedding web page, which similarity is in terms of both content and attributes.

According to the principles of the invention, there is provided a system and method for prioritizing information items embedded in a document, the method comprising the steps of: constructing one or more feature vectors for the embedding document, the feature vectors including: a content feature vector and an attribute feature vector, or both, the content feature vector characterizing content of the document, the attribute feature vector characterizing attributes of the document; constructing one or more feature vectors for an embedded item in the document, the feature vectors including: a content feature vector and an attribute feature vector, or both; computing a similarity measure between the item embedded in the document and the embedding document, the similarity measure based on a comparison of either a respective content feature vector and an attribute feature vector, or both, constructed for each embedded item and a respective content feature vector and an attribute feature vector, or both, constructed for the embedding document; and, assigning a priority to the embedded item based on the computed similarity measures. This is preferably an iterative process so that all items embedded in the embedding document may be prioritized.

Advantageously, the system and method for prioritizing embedded information items such as inline Web objects is performed in a manner transparent to the content author and provider. That is, the system and method for prioritizing embedded information items such as inline Web objects does not require human intervention nor change of HTML syntax, and is deployable on a variety of computing devices, including Web servers, proxies and clients.

### BRIEF DESCRIPTION OF THE DRAWINGS

Further features, aspects and advantages of the apparatus and methods of the present invention will become better understood with regard to the following description, appended claims, and the accompanying drawings where:

FIG. 1 is a block diagram of an overall architecture in which the present invention can operate, formed in accordance with one embodiment of the present invention.

FIG. 2 is a logical flow diagram illustrating the process of prioritizing embedded information items.

FIG. 3 is a block diagram illustrating an exemplary attribute feature vector.

### DETAILED DESCRIPTION OF PREFERRED EMBODIMENTS

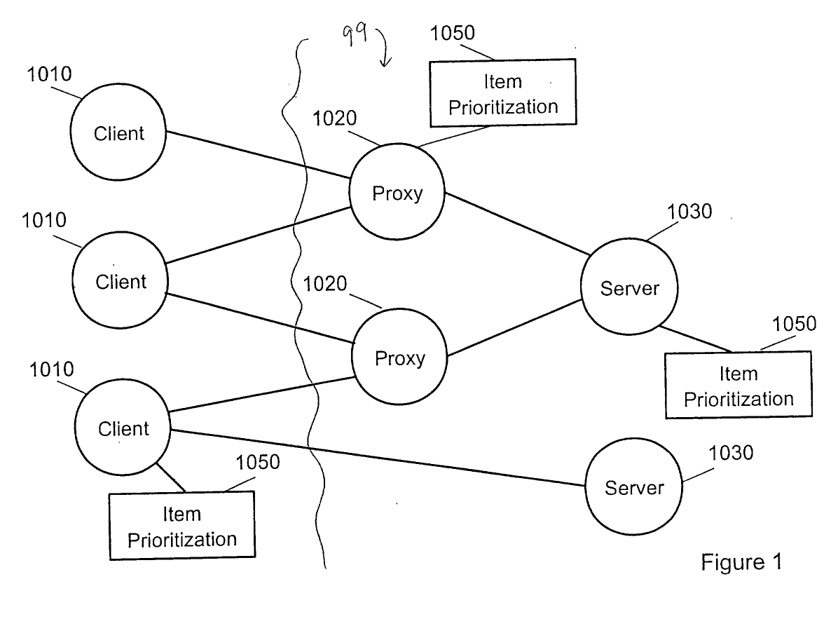

The present invention may be more fully understood with reference to FIG. 1, which shows an overall system architecture in which a preferred embodiment of the invention operates. The components of the system illustrated in FIG. 1 includes one or more client devices 1010, and servers and/or proxies such as proxy server devices 1020 and web-servers 1030 that comprise the Web environment 99.

FIG. 1 further exemplifies an item prioritization process 1050 according to the present invention, as described in greater detail herein, which assigns priorities to inline elements embedded in documents, including for example, documents comprising HTML, XML or like web-based content (i.e., web-page) receivable by a computer device, e.g., PC or hand-held, personal digital assistants (PDA), etc., whether physically or wirelessly connected to the Internet. These priority processes 1050 are intended for deployment on a client device 1010, on a proxy 1020, or, on a server device 1030.

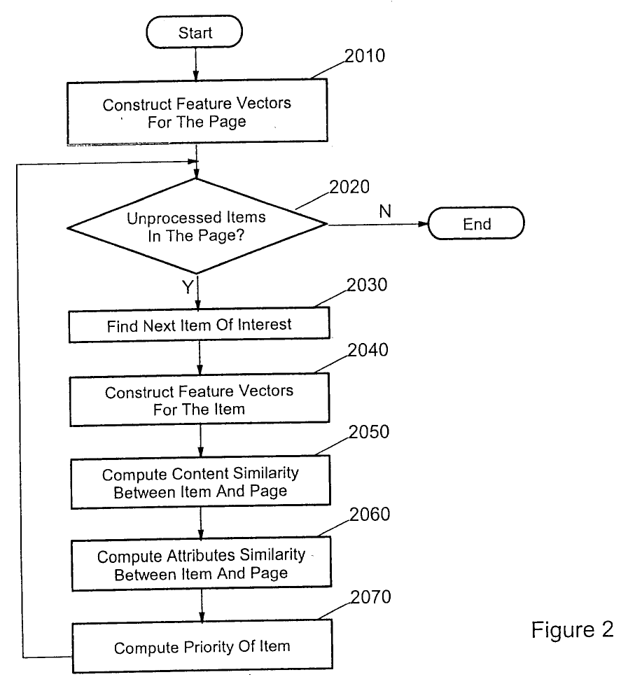

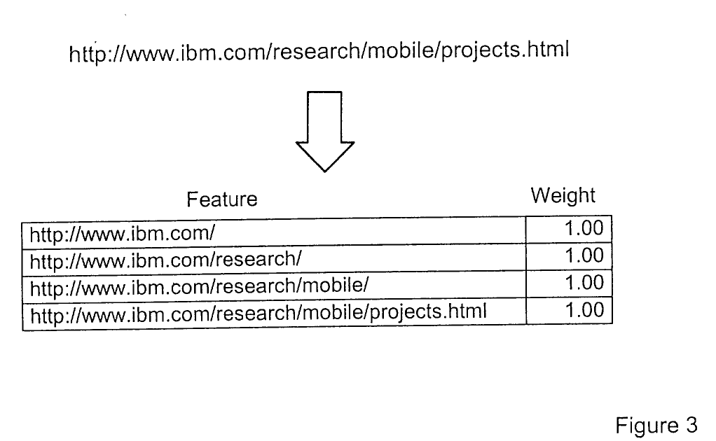

FIG. 2 is a flow chart depicting the prioritization process 1050 of the present invention according to a preferred embodiment. In step 2010, there involves the step of constructing a content feature vector and an attribute feature vector for the embedding web (e.g., HTML) page. The content feature vector characterizes the content of the page. It is generally known to those of ordinary skill in the art how such a content feature vector may be constructed. The content feature vector, for example, may be composed of words extracted from the HTML text where each word is given a weight equal to the frequency of the word's appearances in the page. The attribute feature vector characterizes the attributes of the embedding page. The attributes refer to the location, and the type and size, etc. of the page. Attributes feature vectors will be discussed in greater detail herein with respect to FIG. 3. Further details for generating content and attribute feature vectors may be found in commonly-owned, co-pending U.S. patent application Ser. No. _(YOR920020147US1, Attorney Docket 15622) entitled SYSTEM AND METHOD FOR ENABLING DISCONNECTED WEB ACCESS, the contents and disclosure of which is incorporated by reference as if fully set forth herein.

Referring to FIG. 2, steps 2020 to 2070 represent an iterative process for determining priority of all inline Web objects of the Web page. At step 2020, a determination is first made as to whether any unprocessed item of interest remains in the web page. If no more items exist, then the process will terminate. If there are in-line items remaining, the process proceeds to step 2030, where the next inline object is located. This is performed, for example, by scanning the Web page (e.g., HTML) text until a URL reference is found. In step 2040, a content feature vector and an attribute feature vector are constructed for the inline object. The content feature vector characterizes the content of the inline object. According to a preferred embodiment of the present invention, the content feature vector for an inline object is built from text that appears in a window surrounding the immediately enclosing HTML element (URL reference). For example, in one embodiment, this window may comprise the enclosed URL reference plus a predetermined number of words, e.g., 50 words surrounding the enclosed inline object (i.e., before and after the enclosed URL reference). One skilled in the art may recognize that there are other ways to construct a content feature vector for an inline object. Further with regard to step 2040, FIG. 2, the attribute feature vector is constructed that characterizes the attributes of the inline object. Next, at step 2050, the content similarity between the inline object and the embedding page is computed as the distance between the content feature vector for the inline object and the content feature vector for the embedding web page. In step 2060, the attribute similarity between the inline object and the embedding page is computed as the distance between the attribute feature vector for the inline object and the attribute feature vector for the embedding page. It is to be appreciated that a number of metrics may be used for computing the distance of two vectors, for example, the cosine distance. Finally, at step 2070, the priority of the inline object is computed as a weighted sum of the two similarity measures derived in steps 2050 and 2060 respectively, where the weighting factor implemented is a configurable parameter.

FIG. 3 illustrates how an attribute feature vector may be constructed. According to a preferred embodiment of the present invention, the attribute feature vector for a Web object, whether it is an HTML page or an inline object, includes features that correspond to the URL of the object and all possible prefixes of the URL. Further, a uniform weight is assigned to each of the features. An example attribute feature vector for the object whose URL is http://www.ibm.com/research/mobile/projects.html is illustrated in FIG. 3. Specifically, the attribute feature vector includes the following features: http://www.ibm.com/; http://www.ibm.com/research/; http://www.ibm.com/research/mobile/; and http://www.ibm.com/research/mobile/projects.html. One skilled in the art will recognize that there are other ways of decomposing a URL to form features in the attribute feature vector, and that attribute features may also be extracted from sources such as the HTTP headers and the head element of an HTML document.

Referring back to FIG. 1, the prioritization process according to the method of the present invention, may be performed by a web-browser residing in a client device 1010. An example application of the priority process 1050 may be to prioritize images and download images of a web page based on their significance. Alternatively, or in addition, the proxy device 1020 may implement the prioritization process 1050, for example, if a client is “thin” and does not have processing power or capacity for downloading certain embedded items. For example, if a thin client were to download images embedded in a web page, a proxy device 1020 may be required to first transcode the images, e.g., reduce their fidelity (e.g., resolution, size, color depth, etc.) according to a prioritization process. That is, based on their determined priority, fidelity for more important images may be preserved with less fidelity preserved for less important images. Alternatively, or in addition, the server device 1030 may implement the prioritization process 1050, if there is insufficient network bandwidth to handle all of the incoming requests. In such a case, the server device 1030 may transcode the images in the manner described, based on prioritization process.

The description of the present invention has been presented for purposes of illustration and description, and is not intended to be exhaustive or limited to the invention in the form disclosed. Many modifications, variations and extensions will be apparent to those of ordinary skill in the art. All such modifications, variations and extensions are intended to be included within the scope of the invention as defined by the appended claims.

What is claimed is:

Having thus described our invention, what we claim as new and desire to secure by Letters Patent is:

1. A method for prioritizing information items embedded in a document, comprising the steps of:
a) constructing one or more feature vectors for said embedding document, said feature vectors including: a content feature vector and an attribute feature vector, or both, said content feature vector characterizing content of said document, said attribute feature vector characterizing attributes of the document;
b) constructing one or more feature vectors for an embedded item in said document, said feature vectors including: a content feature vector and an attribute feature vector, or both;
c) computing a similarity measure between said item embedded in said document and said embedding document, said similarity measure based on a comparison of a respective content feature vector, an attribute feature vector, or both, constructed for each embedded item and a respective content feature vector, an attribute feature vector, or both, constructed for said embedding document; and,
d) assigning a priority to said embedded item based on said computed similarity measures.

2. The method of claim 1, wherein said embedding document is an HTML or like web page.

3. The method of claim 1, wherein said step of computing a similarity measure between an item embedded in said document and said embedding document includes computing a distance between a respective feature vector for the inline object and the corresponding feature vector for the embedding page.

4. The method of claim 3, wherein a distance metric used for computing the distance of two feature vectors includes a cosine distance.

5. The method of claim 1, wherein content of said embedding document is expressed as one or more of: relevant words, phrases or combinations thereof in text of the embedding document.

6. The method of claim 1, wherein each of one or more of: relevant words, phrases or combinations thereof in text of the embedding document includes a weight associated therewith.

7. The method of claim 1, wherein content of said embedded item document is expressed as one or more of: relevant words, phrases or combinations thereof in text surrounding the item in embedding document.

8. The method of claim 1, wherein the attributes of said embedding document is expressed as one or more of: type, size, and location information associated with said embedding document.

9. The method of claim 8, wherein each of one or more of: type, size, and location information associated with said embedding document includes a weight associated therewith.

10. The method of claim 9, wherein the said location information includes a referencing URL and its prefixes.

11. The method of claim 1, further comprising iteratively repeating steps b)-d) for prioritizing each item embedded in said embedding document.

12. A system for prioritizing information items embedded in a document comprising:
means for constructing one or more feature vectors for said embedding document, said feature vectors including: a content feature vector and an attribute feature vector, or both, said content feature vector characterizing content of said document, said attribute feature vector characterizing attributes of the document;
means for constructing one or more feature vectors for an embedded item in said document, said feature vectors including: a content feature vector and an attribute feature vector, or both;
means for computing a similarity measure between said item embedded in said document and said embedding document, said similarity measure based on a comparison of a respective content feature vector, an attribute feature vector, or both, constructed for each embedded item and a respective content feature vector, an attribute feature vector, or both, constructed for said embedding document;
wherein a priority is determined for said embedded item based on said computed similarity measures.

13. The system for prioritizing information as claimed in claim 12, implemented in a client computing device.

14. The system for prioritizing information as claimed in claim 12, implemented in a proxy server device.

15. The system for prioritizing information as claimed in claim 12, implemented in a server device.

16. A program storage device readable by machine, tangibly embodying a program of instructions executable by the machine to perform method steps for prioritizing information items embedded in a document, the method steps comprising:
a) constructing one or more feature vectors for said embedding document, said feature vectors including: a content feature vector and an attribute feature vector, or both, said content feature vector characterizing content of said document, said attribute feature vector characterizing attributes of the document;
b) constructing one or more feature vectors for an embedded item in said document, said feature vectors including: a content feature vector and an attribute feature vector, or both;
c) computing a similarity measure between said item embedded in said document and said embedding document, said similarity measure based on a comparison of a respective content feature vector, an attribute feature vector, or both, constructed for each embedded item and a respective content feature vector, an attribute feature vector, or both, constructed for said embedding document; and,
d) assigning a priority to said embedded item based on said computed similarity measures.

17. The program storage device readable by machine according to claim 16, wherein said embedding document is an HTML or like web page.

18. The program storage device readable by machine according to claim 16, wherein said step of computing a similarity measure between an item embedded in said document and said embedding document includes computing a distance between a respective feature vector for the inline object and the corresponding feature vector for the embedding page.

19. The program storage device readable by machine according to claim 18, wherein a distance metric used for computing the distance of two feature vectors includes a cosine distance.

20. The program storage device readable by machine according to claim 16, wherein content of said embedding document is expressed as one or more of: relevant words, phrases or combinations thereof in text of the embedding document.

21. The program storage device readable by machine according to claim 16, wherein each of one or more of: relevant words, phrases or combinations thereof in text of the embedding document includes a weight associated therewith.

22. The program storage device readable by machine according to claim 16, wherein content of said embedded item document is expressed as one or more of: relevant words, phrases or combinations thereof in text surrounding the item in embedding document.

23. The program storage device readable by machine according to claim 16, wherein the attributes of said embedding document is expressed as one or more of: type, size, and location information associated with said embedding document.

24. The program storage device readable by machine according to claim 23, wherein each of one or more of: type, size, and location information associated with said embedding document includes a weight associated therewith.

25. The program storage device readable by machine according to claim 24, wherein the said location information includes a referencing URL and its prefixes.

26. The program storage device readable by machine according to claim 16, further comprising iteratively repeating steps b)-d) for prioritizing each item embedded in said embedding document.
